(19) United States
(12) Patent Application Publication
(10) Pub. No.: US 2009/0007266 A1
(43) Pub. Date: Jan. 1, 2009

(54) Adaptive Defense System Against Network Attacks

(75) Inventors: Jo-Yu Wu, Fremont, CA (US); Yeejang James Lin, San Jose, CA (US)

Correspondence Address: Wang Law Firm, Inc., 4989 Peachtree Parkway,, Suite 200, Norcross, GA, 30092, US

(73) Assignee: Reti Corporation, Taipei (TW)

(21) Appl. No.: 11/771,305

(22) Filed: Jun. 29, 2007

(51) Int. Cl. G06F 17/00

(52) U.S. Cl. 726/22

(57) ABSTRACT

A system and method according to the invention provide an efficient resource allocation when receiving connection requests from different servers for data transfer and the efficient resource allocation is achieved by identifying and assigning a quality factor to each originating server. When an originating server presents an abusive behavior, it may be assigned to a state that has a low quality factor, thus receiving little resource from the system.

### BACKGROUND OF THE INVENTION

1. Field of the Invention

The present invention generally relates to data communications, and more specifically, relates to a defense system and method for against network attacks.

2. Description of the Related Art

Data transfer from one computer to another computer as data packets that travel through one or more data networks. A data packet consists of three elements: the first element is a header, which marks the beginning of the packet; the second element is the payload, which contains the information to be carried in the packet; the third element is a trailer, which marks the end of the packet. A good analogy is to consider a packet to be like a letter: the header is like the envelope, and the data area is whatever the person puts inside the envelope. A large data may be broken into several small pieces and shipped through several data packets.

As the data packets travel through the data network, the header is analyzed by gate servers that handle the data packets. The header includes the information about the source and the destination of the data. The source information includes the network address and/or the protocol port of a source server and the destination information includes the network address and/or the protocol port of a destination server.

Normally, after the data in the data packets are reassembled at the destination, they are checked against viruses or searched patterns. If no virus is found, the data is then forwarded to its final destination. FIG. 1 illustrates a traditional architecture 100 for a data transfer. The data is sent from a source 102 to a destination 106 passing through a server 104. A large data may be divided into smaller data packets at the source 102, reassembled by the server 104, checked against viruses at the server 104, and forwarded to the destination 106.

FIG. 2 illustrates a traditional architecture 200 for checking viruses and patterns. The architecture reflects store-and-forward approach, in which the data packets are received by a receiving unit 202 and placed in a temporary storage unit 204 until all the data packets for a particular data stream are received. After the data stream is complete and reassembled, it is forwarded to a processor 206 for virus and pattern checking. If the data stream is found free of viruses or searched patterns, the data stream is then forwarded to the proper application. While the data stream is not complete, it is placed in the temporary storage unit 204. The virus checking and pattern searching processes do not start until all the data packets are received.

During the searching process, all the arriving data packets are treated in the same way, receiving the equal amount of resources from the server even some data packets are from data sources that are more trustworthy than other. Therefore, it is desirous to have an apparatus and method that enable smart allocation of system resources during screening and forwarding of the data packets depending on the quality of sources of these data packets, and it is to such apparatus and method the present invention is primarily directed.

### SUMMARY OF THE INVENTION

Briefly described, the apparatus and method of the invention enables an efficient allocation of resource when handling multiple connections for data transfer. In one embodiment, there is provided a method for assigning system resources to connections associated with an originating server and a destination server in a communication network. The method includes receiving a connection request from an originating server, creating a connection for the connection request, moving the origination server to a first state, validating the originating server, if the originating server has been validated, moving the originating server to a validated state, if the originating server is in the validated state and the originating server presents an abusive behavior, moving the originating server to a penalty state, and assigning system resources to the connection according to which state the originating server is in.

In another embodiment, there is provided an apparatus for assigning system resources to connections associated with an originating server and a destination server in a communication network. The apparatus includes a communication unit, a processing unit, and a storage unit. The communication unit is capable of receiving a connection request from the originating server in the communication network. The processing unit is capable of creating a connection for the connection request, moving the originating server to a first state, validating the originating server, if the originating server has been validated, moving the originating server to a validated state, if the originating server is in the validated state and the originating server presents an abusive behavior, moving the originating server to a penalty state, and assigning system resources to the connection according to which state the originating server is in. The storage unit is capable of storing state information for the originating server.

In yet another embodiment, there is provided a system for adaptively managing data traffic to and from a data network. The system includes a data traffic control system, a real time traffic control system, a content monitoring system, and a central system. The data traffic control system is capable of handling connection requests from a plurality of originating servers, each connection request being associated with an originating server and a destination server, and also capable of validating each originating server and generating a first message when an originating server cannot be validated. The real time traffic control system is capable of monitoring the data network and generating a second message indicative of a condition of an originating server in the data network. The content monitoring system is capable of monitoring content of a data traffic and generating a third message indicative of a data content of a connection in the data traffic. The central system is capable of interfacing with the data traffic control system, the real time traffic control system, and the content monitoring system. The central system adaptively controls the data traffic according to messages received from the data traffic control system, the real time traffic control system, and the content monitoring system.

The present system and methods are therefore advantageous as they enable an efficient allocation of resources to multiple data transfer requests by identifying and assigning a trust level to each connection. Other advantages and features of the present invention will become apparent after review of the hereinafter set forth in Brief Description of the Drawings, Detailed Description of the Invention, and the Claims.

### BRIEF DESCRIPTION OF THE DRAWINGS

FIG. 1 depicts a prior art schematic for a data transfer process.

FIG. 2 illustrates a prior art virus scanning architecture.

FIG. 3 illustrates architecture of an adaptive defense system according to one embodiment of the invention.

FIG. 4 illustrates an exemplary state transition diagram for each server according to one embodiment of the invention.

FIG. 5 illustrates architecture of a server according to one embodiment of the invention.

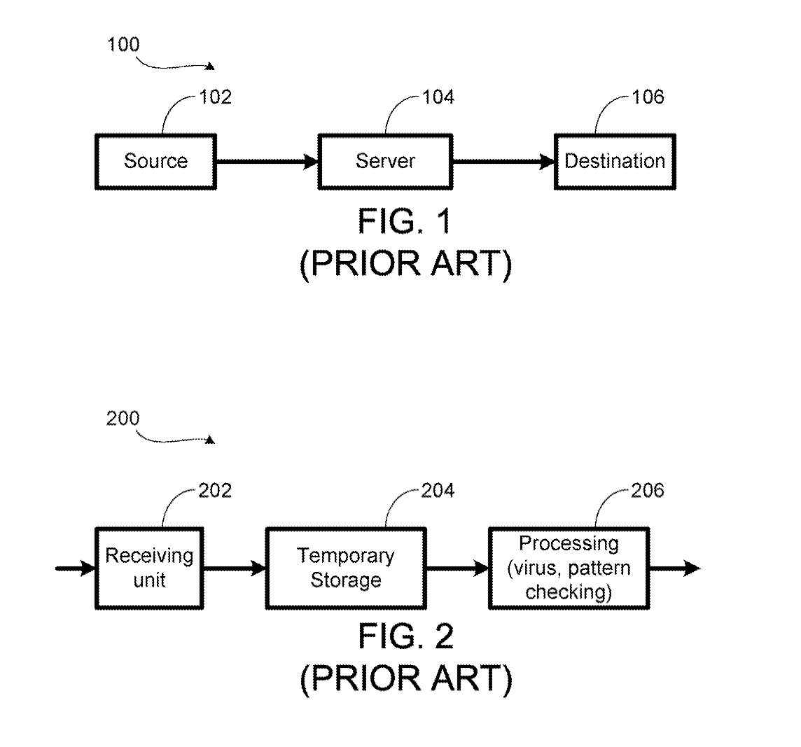

### DETAILED DESCRIPTION OF THE INVENTION

In this description, the term “application” as used herein is intended to encompass executable and nonexecutable software files, raw data, aggregated data, patches, and other code segments. The term “exemplary” is meant only as an example, and does not indicate any preference for the embodiment or elements described. The terms “system” and “server” are used interchangeably. Further, like numerals refer to like elements throughout the several views, and the articles “a” and “the” includes plural references, unless otherwise specified in the description.

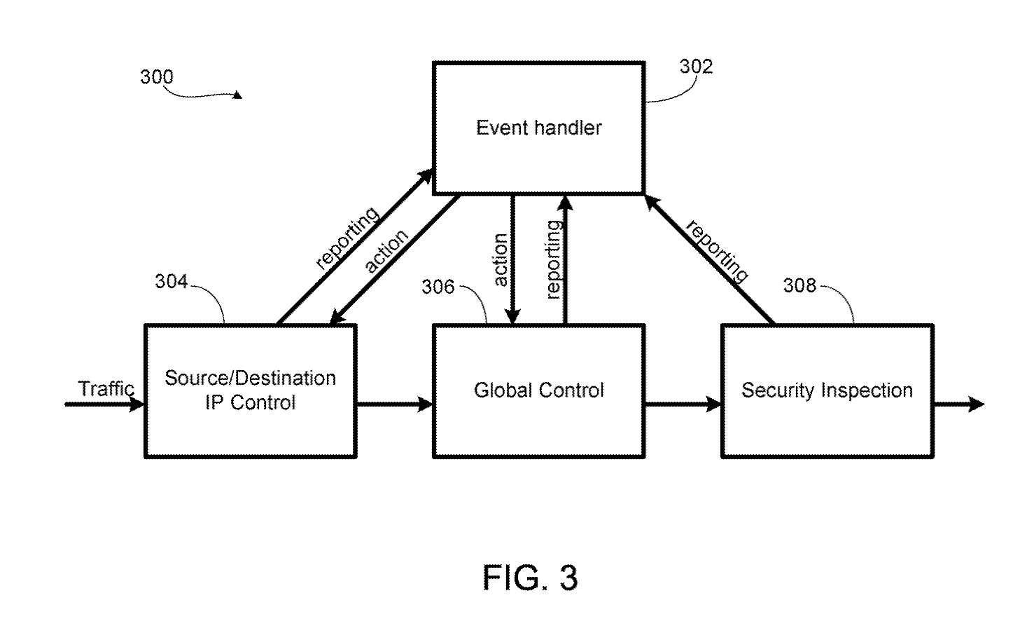

In overview, the system and method of the invention provide an adaptive and proactive defense mechanism for handling data traffic through a data network. The system proactively uses past history and current behavior of each server or user and current traffic condition of the data network to allocate resources for each connection. The system also uses information based on the behavior and the content of each connection taken from real time to determine the resource allocation. FIG. 3 illustrates architecture of a proactive and adaptive system 300 according to one embodiment of the invention. The data traffic arriving at a server equipped with the adaptive system 300 will be processed through three sub-systems; data traffic control (a.k.a. IP control) sub-system 304, real time traffic control (a.k.a. global control) sub-system 306, and content monitoring (a.k.a. security inspection) sub-system 308. Three sub-systems interface with a central monitoring system (a.k.a. event handling system) 302. Each subsystem reports events to the event handling system 302 and receives instructions for actions from the event handling system 302.

The events reported by each sub-system may be processing results from each sub-system. For example, the IP control sub-system 304 verifies connection requests from different sources and if a source is determined to be a bogus source, i.e., cannot be validated, this determination is reported as an event to the event handling system 302. Upon learning that an IP cannot be validated, the event handling system 302 may instruct the IP control sub-system 304 to reject the connection request or otherwise place a penalty on the connection. There is ac credit score for each connection and the credit score is based on the recent behavior as observed by the IP Control sub-system 306 and Security Inspection sub-system 308. The credit score may be associated with a source server and/or a destination server of the connection. Alternatively, the credit score may also be associated with a user originating such connection. The credit score may determine how much resource is assigned to the connection. The IP control sub-system 304 may also detect and report any connection engaging in abusive behaviors, such as brute-force denial of service (DoS) attacks.

The real time traffic condition as monitored by the global control sub-system 306 is reported to the event handling system 302. If the volume of the traffic is high, the event handling system 302 may instruct the IP control sub-system 304 to adjust traffic volume for each server or user by adjusting its per server or user resource allocation. The global control sub-system 306 allows the adjustment of data transfer rate for each connection based on the total number of connection requests and the global control sub-system 306 also polices the total data transfer rate. The global control sub-system 306 can block, limit or police data traffic when instructed by the event handling system 302.

The security inspection sub-system 308 checks the content and behavior of each connection and reports them to the event handling system 302. The security inspection sub-system 308 also enforces policies for the network and the policies may be user based, application based, or server based. The policy may limit what a user can do during a data transfer, what port an application can use, or how many connections can be accepted from a specific server or established for a specific server. The undesired behaviors that the security inspection sub-system 308 watches for may include port scanning, DoS/DDoS (distributed denial of service) attacks, and undesirable intrusions that can be identified from traffic patterns. The undesirable contents that can be detected by the security inspection sub-system 308 may include viruses, worms, and confidential or private information. If the security inspection sub-system 308 detects the content of data transfer for a particular connection is undesirable, the security inspection sub-system 308 will report it to the event handling system 302, which in turn may instruct the IP control sub-system 304 to terminate the connection.

Because of these sub-systems, the adaptive system 300 is able to correlate information received from different sub-systems and allocate adaptively resources to each connection according to the real time network traffic condition and characteristics of each connection. Each sub-system provides some information to the adaptive system 300, which in turn correlates the information to notifications received from other sub-systems and then instructs each sub-system what actions should be taken regarding the data traffic. Based on the information from the sub-systems, the adaptive system 300 proactively identifies malicious and misbehaved users and/or connections.

The system and method according to the invention provide an efficient resource allocation when receiving connection requests from different servers for data transfer and the efficient resource allocation is achieved by identifying and assigning a quality factor to each originating server. When a large file is transmitted from one computer system (server) to another computer system (server), it is transmitted through multiple data packets. The data packets are transmitted as a data stream between the origination server (system) and the destination server, passing through a gate server. Before the data transfer is started, the originating server sends a connection request for the data stream to the gate server, and after the connection is established, the data packets can then be transferred from the originating server to the destination server. Each data stream is assigned a connection and each connection is identified by data's origination server's network address and port number and data's destination servers network address and port number. Each connection is associated with an origination server and a destination server. Each connection is assigned a certain amount of resource for handling of data packets in the connection. Instead of sharing the available resource equally amount all co-existing connections, or all servers, the system according to the invention will assess the connection and its originating server, assign a priority level to the originating server, and assign the resource to the connections according to the priority level of its originating server. The priority level may also depend on the destination server. The priority level is a reflection of trustworthiness of the originating server. If an originating server has not gone through a validation process, such as the TCP's 3-way handshake, then the connection has a certain priority level. After the connection finishes the validation, then the priority level may be increased. If the connection is from a server that presents undesired behavior, such as trying to open new connections at a very high rate, then the connection will have a lower priority level.

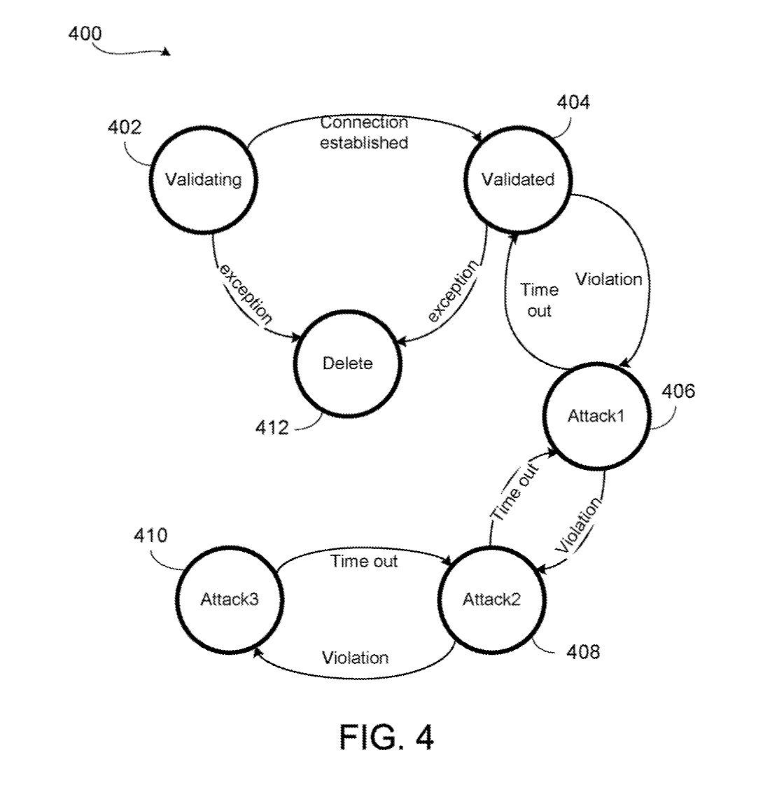

FIG. 4 depicts a state diagram 400 for the states assigned to an originating server according to one embodiment of the invention, where each state corresponds to a quality factor. The quality factor of each state affects the resource that is available to the connections in that state. When a first data transfer request is received from an originating server by a gate server, the gate server creates a connection entry in its IP context table for this request and checks whether the originating server is listed among its recognized servers. The data transfer request may be transmitted through a network using different protocols, such as TCP/IP, UP, etc. The network may be wired or wireless. The status of the connection for the originating server is assigned to validating state 402. A server is a recognized server if there are established connections between the originating server and a destination server that passes through the gate server. If the originating server is a recognized server. i.e., the originating server has successfully gone through a validation procedure, such as the TCP 3-way handshake procedure, then the connection for the originating server will be moved to validated state 404. If the originating server has not been validated, i.e., gone through a 3-way handshake, then the state of the originating server remains in the validating state and a validation procedure is started. If the connection is a TCP connection, then the TCP 3-way handshake procedure is used to validate the originating server. After the 3-way handshake procedure is completed, the state of the connection for the originating server is moved to the validated state 404. Those skilled in the art will appreciate that other validating procedure may also be employed. Before an originating server is validated, it is considered a bogus server, which means that the server may not have intention to establish real connections or the server may be engaged in a brute-force denial-of-service (DoS) attack.

After a server is validated, all future connection requests from the same server will automatically enjoy the same status. The information for each connection will be entered into a per-IP context table. For example, if there are 10 connections from the same server, then there will be 10 entries in the context table associated with the server's IP address. Alternatively, a larger table may be used in which there is an entry for each IP address of a server and the connections from the same server are listed as items under the same entry.

While at the validating state, the gate server waits for the originating server to be validated through the validation procedure. If an exception occurs before the originating server is validated, the state associated with the connection for the originating server is moved to a delete state 412 and the entry for the originating server in the per-IP context table will be deleted. The exception may be an event that is not part of normal validating protocol events, an exception may be a lack of response from the originating server within a prescribed period or an out-of-sequence event/signal received from the originating server. The proper response to an exception may be programmed into the gate server. In one embodiment, if there are two entries for two connection requests from the same originating server and an exception occurs for one of the connection requests, it is assumed that the originating server is a bogus server and both entries will be deleted. Alternatively, in a more lenient approach, the gate server may delete the entry associated with the connection that had exception and then continue to wait for the validation response for other connection requests to return. In this alternative approach, if all the connection requests have exceptions, then the entry associated with the originating server will be deleted from the per-IP context table.

After the originating server is validated and its connection moved to the validated state 404, the data transfer between the originating server and the destination server passing through the gate server, occurs in an ordinary fashion. If during the data transfer an exception occurs, i.e. the data stream between the originating server and the destination server is interrupted, the gate server will then change the connection associated with the originating server to delete state 412 and the entry associated with the originating server will be deleted from the per-IP context table. Alternatively, the gate server may reset the connection and restart the data transfer, thus keeping the connection state in the validated state 404.

After the connection state is moved to the validated state 404 and the data transfer begins, the gate server monitors the originating server. If the originating server presents some abusive behavior, then the gate server will impose a penalty on the originating server. One example of the abusive behavior is high connection request rate. If the originating server starts to send many connection requests to the destination server through the gate server, it is an indication that the originating server is exhibiting an abusive behavior. If the connection request rate exceeds certain predefined thresholds, the gate server may take some actions toward the requests and communications from this originating server. If the connection request rate exceeds a predefined rate, the originating server may be considered as hostile and initiating an attack to the destination server through the gate server. Another example of the abusive behaviors IP/port scanning, i.e., the originating server sending connection requests at a high rate to different ports or IP addresses.

One penalty that may be imposed on the originating server that is exhibiting an abusive behavior is to place the connection associated with the originating server in one penalty state. When the originating server is in the penalty state, it receives fewer resources from the gate server. In one implementation of the invention, the penalty state may be further defined into three attacks states, each state being associated with a predefined threshold number of connection requests. For example, if the connection request rate exceeds 1000 requests/sec., the connection state of the originating server will be moved to state attack1 406 in FIG. 4. If the connection request rate increases to 2000 requests/sec, then the connection state of the originating server will be moved from attack1 406 to attack2 408. If the connection request rate continues to increase to 3000 requests/sec, then the connection state of the originating server will be moved from attack2 408 to attack3 410. Those skilled in the art will appreciate other mechanisms for handling increasing connection requests involving different number of states and different threshold of the number of requests may also be adopted.

It is understood that not all requesting rate exceeding a predefined limit is an abusive behavior. A burst is a sudden surge of connection requests and generally lasts for a short period. A burst in the connection requests is not considered as an abusive behavior. However, a sequence of bursts within a short period may be accumulated and compared against a predefined threshold, and if the accumulated connection request exceeds the predefined threshold, the sequence of bursts will then be considered as an abusive behavior.

After the connection state is moved to an attack state to indicate that the originating server is initiating an attack and being “watched,” a timer will be set. If the originating server stops the abusive behavior for a duration defined by the timer, i.e.; no longer sends a high rate of connection requests, then the connection state may be moved from, for example, attack1 406 back to validated 404, or from attack2 408 back to attack1 406. If the same abusive behavior continues, then the connection state will remain in an attack state and the timer reset.

The effect of being in a specific state, whether in a validated state or an attack state, affects the resource that is available for the connection and for the server associated with the connection. The resource available at the gate server to handle connections and data transfers is divided into different classes, and each class is associated with one connection state. All the connections in the same connection state share the resource assigned to the class associated with that connection state. According to one embodiment, the resource can be assigned the following way: a runtime_rate is assigned to validated state 404, runtime_rate/2 is assigned to attack1 state 406, runtime_rate/3 is assigned to attack2 state 408, runtime_rate/5 is assigned to attack3 408, and runtime_rate/5 is assigned to validating 402. Runtime_rate can be configured at run time based on the network or server condition. Alternatively, the gate server may assign resources to each connection according to the past history of the originating server. For example, if the originating server for certain connections has a prior history of abuses, the connection request from this originating server may still be accepted, but the gate server will watch this originating server closely. The gate server may set a lower threshold for each of triggering events for state transitions from the validated to attack states.

Besides being able to configure the resources assigned to each class or each connection state, the present invention also enables a user to configure transitions from one state to another according to exceptions that may happen during a data transfer. For example, if an originating server requests a connection and no data is transferred after the connection is established, this exception can be programmed into the gate server. Subsequently, if a connection is established, in validated state 404, but no data transfer is effected then the connection can be moved to delete state 412. when an exception occurs with one connection, the user may choose to have that particular connection to be moved to a different state or deleted. Alternatively, the user may also choose to have all the connections associated with that server moved to a new state.

The transition from one state to another state depends mainly on the status of the originating server and each originating server has a score. The score for an originating server depends on a large set of data. The score may depend on past successful connections between the originating server and a destination server, the failure rate of past connection requests (number of false connection requests), past connection qualities, etc. The score of an originating server affects the amount of resource that is assigned to connections from the same server. The connection quality of a connection may be affected by the resource assigned to the connection. The past connection history such as volume of connections, connections without data transfer, short connections (frequent drops), etc. may affect the score, which in term affects the quality for a current connection. Not all past histories are treated the same, older connection histories have lesser weight than more recent connection histories.

The score is a function of different factors related to the originating server as indicated by the equation below.

Score (server)=Function (success connection rate; failure rate; connection quality; weight of history; . . . );

The weight of each factor may be adjusted by a user and the score of an origination server may affect the resources that will be assigned to the connections originated from this server as indicated by the equation below.

Resource (server)=Function (Score).

The transition from one state to another state may also depend on the status of the destination server. In an alternative embodiment, a connection may be placed in one of the attack states based on the status of its destination server. For example, when a destination server receives 10 connection requests from 1000 different originating servers the destination server will be considered under attack, even every individual originating server does not present any abusive behavior. Because the destination server is under attack, the gate server will limit the access and resources to this destination server. The limitation will be placed to all of the originating servers that maintain connections to this destination server. This attack condition may be detected by the global control subsystem 306 and reported to the event handling system 302. Subsequently, the event handling system 302 may instruct the IP control sub-system 304 to place the originating servers into penalty states.

Although six states are illustrated in FIG. 4, those skilled in the art will appreciate that different number of connection states wherein transition between connection states are caused by events monitored by the gate server, may be implemented without departing from the spirit and scope of the present invention. Though the FIG. 4 is described in term of state transitions for a connection associated with a server, those skilled in the art will appreciate that FIG. 4 and its description are equally applicable to describe the state of a server during a data transfer.

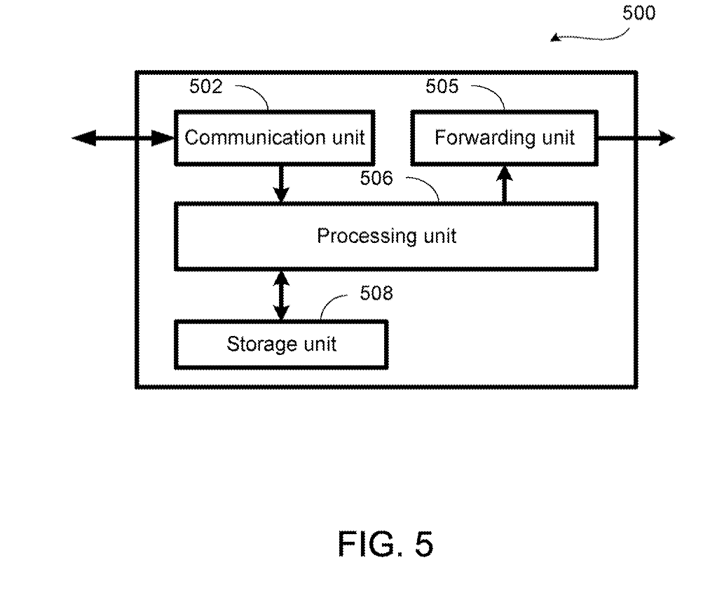

FIG. 5 illustrates architecture 500 of a gate server according to one embodiment of the invention. The gate server includes a communication unit 502 for communicating with a data network a forwarding unit 504 for forwarding data packets to another processor a processing unit 506 for monitoring the connection requests and data transfers, and a storage unit 508 for storing connection state information. The communication unit 502 and the forwarding unit 504 may be a single combined unit capable of dual functions. The communication unit 502 receives a connection request from an originating server through the data network and starts the validation procedure to validate the originating server. The gate server checks to see if the originating server has been validated before by checking the storage unit 508. If the originating server is listed in a connection table in the storage unit 508, there is no need to validate the originating server and the connection newly created may be moved to validated state 404.

If there was no prior connection established between the originating server and the gate servers then the gate server places the new connection in validating state 402 and commences the validating procedure. The validating procedure may be a handshaking according to a network protocol such as TCP. During the validation procedure initiated by the processing unit 506, the communication unit 502 transmits and receives validation protocols to and from the originating server. After the originating server is validated the processing unit 506 changes the connection state for the gate server/connection to validated 404. After a connection is established and data transfer started, the data packets are received by the communication unit 502 and forwarded to a destination server by the forwarding unit 504. The processing unit 506 monitors the transfer and the state information regarding each connection and originating server is saved in the storage unit 508.

In operation, when a user at an origination server wants to download a file from a website hosted by a remote server, the user clicks a link associated with the file and starts the data transfer process. A data transfer process is started by first sending a connection request from the origination server to the remote server, and the connection request is first received by a gate server. The gate server checks whether the origination server is a recognized server, i.e., whether the computer has been validated. If the origination server has gone through a validation procedure, then a connection will be created for this data transfer and the connection will be assigned to the validated state. After the connection request is accepted and a connection created, the gate server forwards the connection request to the remote server and the normal data transfer is conducted according to a previously established protocol. The connection will share the resource assigned to validated state.

The gate server will monitor the data transfer and the connection requests coming from an origination server. If the gate server detects a surge of connection requests coming from the origination server that exceed a predefined threshold, which is an indication that the gate server may be under attack by the origination server the gate server moves the connection state associated with the origination server to attack1 state. Alt the connections associated with the origination server wilt be moved to attack1 state. If the number of connection requests continues high, the gate server will keep the connection state of the origination server in this state. If the number of connection requests increases even higher, the gate server will move the connection state of the origination server to attack2 state, thus further limiting the resources assigned to the origination server. If the origination server is moved to the attack1 state and the number of connection requests drops below the predefined threshold and stays low for a predefined period, at the end of the predefined period the connection state of the origination server is moved back to validated thus enabling the connections from the origination server to receive more resources from the gate server. If later, the origination server again presents some abusive behavior, the origination server again will be penalized by moving to a penalized state and receiving fewer resources from the gate server. The gate server will also monitor the data transfer to a destination server. If the gate server detects that the connection requests to a destination server has exceeded a predefined threshold the gate server may take actions to restrict access to this destination server. The connection requests to a particular destination server coming from many different origination servers may be an indication of a coordinated attack designed to bring down the destination server. Upon detection of this possible attack, the gate server can limit the resource assigned to handle all connection requests to this particular destination server, thus limiting the number of the connection requests allowed to reach the destination server.

Though the description and the example are based on a connection request for a data transfer, the invention is equally applicable for monitoring all communications between two computer systems. The criteria for determining whether a computer system (server) is having an abusive behavior can be easily changed during run time by a user and the resource allocation for each connection can also be changed run time by the user. The treatment of an originating computer system may not be based solely on the existing connections between the originating computer system and a gate computer system, but may also be influenced by the past connection history of the originating computer system. It is understood by those skilled in the art that the past connection history may be refreshed periodically in view that IP address assigned to the originating computer system may be changed periodically.

In view of the method being executable on networking devices and servers, the method can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art.

In the context of FIG. 4, the steps illustrated do not require or imply any particular order of actions, The actions may be executed in sequence or in parallel. The method may be implemented, for example, by operating portion(s) of a server device, such as a network router or network server, to execute a sequence of machine-readable instructions. The instructions can reside in various types of signal-bearing or data storage primary, secondary, or tertiary media. The media may comprise, for example, RAM (not shown) accessible by, or residing within, the components of the network device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM: or EEPROM), flash memory cards, an optical storage device (e.g. CD-ROM, WORM, DVD: digital optical tape), paper “punch” cards, or other suitable data storage media including digital and analog transmission media.

While the invention has been particularly shown and described with reference to a preferred embodiment thereof it will be understood by those skilled in the art that various changes in form and detail may be made without departing from the spirit and scope of the present invention as set forth in the following claims. Furthermore although elements of the invention may be described or claimed in the singular, the plural is contemplated unless limitation to the singular is explicitly stated.

What is claimed is:

1. A method for assigning system resources to connections associated with an originating server and a destination server in a communication network, comprising the steps of:
receiving a connection request from an origination server;
creating a connection for the connection request;
moving the originating server to a first state;
validating the originating server;
if the originating server has been validated, moving the originating server to a validated state;
if the originating server is in the validated state and the originating server presents an abusive behavior, moving the originating server to a penalty state, and
assigning system resources to the connection according to which state the originating server is in.

2. The method of claim 1, further comprising the step of, if the originating server is in the penalty state and no abusive behavior occurs within a predefined period, moving the originating server to the validated state.

3. The method of claim 1, wherein the penalty state further comprising a first attack state, a second attack state, and a third attack state.

4. The method of claim 3, further comprising the step of, if the abusive behavior increases when the originating server is in the first attack state, moving the originating server to the second attack state.

5. The method of claim 1, further comprising the step of checking if there is an entry corresponding to the originating server in an IP context table.

6. The method of claim 1, further comprising the step of assigning the system resources to the connection according to a state of the originating server.

7. The method of claim 1, wherein the abusive behavior being maintaining a high connection request rate that exceeds a predefined limit.

8. The method of claim 1 wherein the abusive behavior being sending connection requests with different port addresses.

9. The method of claim 1, wherein the abusive behavior being sending connection requests with different Internet Protocol addresses.

10. The method of claim 1, further comprising a step of moving the originating server to the penalty state if the connection is part of an attack to the destination server.

11. An apparatus for assigning system resources to a connection associated with an originating server and a destination server in a communication network, comprising:
a communication unit for receiving a connection request from the originating server in the communication network,
a processing unit being capable of
creating a connection for the connection request,
moving the originating server to a first state,
validating the originating server,
if the originating server has been validated, moving the originating server to a validated state,
if the originating server is in the validated state and the originating server presents an abusive behavior, moving the originating server to a penalty state, and
assigning system resources to the connection according to which state the originating server is in, and
a storage unit for storing state information for the originating server.

12. The processing unit of claim 11, further being capable of, if the originating server is in the penalty state and no abusive behavior occurs within a predefined period, moving the originating server to the validated state.

13. The processing unit of claim 11, wherein the penalty state further comprising a first attack state, a second attack state, and a third attack state.

14. The processing unit of claim 13, further being capable of, if the abusive behavior increases when the originating server is in the first attack state, moving the originating server to the second attack state.

15. The processing unit of claim 11, further being capable of, checking if there is an entry corresponding to the originating server in an IP context table.

16. The processing unit of claim 11 further being capable of assigning the system resources to the connection according to a state of the originating server.

17. The processing unit of claim 11, wherein the abusive behavior being maintaining a high connection request rate that exceeds a predefined limit.

18. The processing unit of claim 11, wherein the abusive behavior being sending connection requests with different port addresses.

19. The processing unit of claim 11 wherein the abusive behavior being sending connection requests with different Internet Protocol addresses.

20. The processing unit of claim 11 further being capable of moving the originating server to the penalty state if the connection is pad of an attack to the destination server.

21. A computer-readable medium on which is stored a computer program for assigning system resources to connections associated with an originating server and a destination server in a communication network the computer program comprising computer instructions that when executed by a computing device performs the steps for:
receiving a connection request from the originating server;
creating a connection for the connection request;
moving the originating server to a first state;
validating the originating server;
if the originating server has been validated, moving the originating server to a validated state;
if the originating server is in the validated state and the originating server presents an abusive behavior, moving the originating server to a penalty state; and
assigning system resources to the connection according to a state the originating state is in.

22. A system for adaptively managing data traffic to and from a data network, the system comprising:
a data traffic control system for handling connection requests from a plurality of originating servers, each connection request being associated with an originating server and a destination server, the data traffic control system being capable of validating each originating server and generating a first message when an originating server cannot be validated;
a real time traffic control system for monitoring the data network, the real time traffic control system being capable of generating a second message indicative of a condition of an originating server in the data network;
a content monitoring system for monitoring content of a data traffic, the content monitoring system being capable of generating a third message indicative of a data content of a connection in the data traffic; and
a central system for interfacing with the data traffic control system, the real time traffic control system, and the content monitoring system,
wherein the central system adaptively controls the data traffic according to messages received from the data traffic control system the real time traffic control system, and the content monitoring system.

23. The system of claim 22, wherein the real time traffic control system further being capable of assigning resources to a connection according to the condition of the originating server in the data network.

24. The system of claim 23, wherein the real time traffic control system further being capable of enforcing a data transfer rate for the connection.

25. The system of claim 22, wherein the central system further being capable of receiving the third message from the content monitoring system and then instructing the data traffic control system to terminate the connection.

26. The system of claim 22, wherein the real time traffic control system further being capable of generating a fourth message indicative of a condition of a destination server in the data network.

27. The system of claim 26, wherein the real time traffic control system further being capable of assigning resources to a connection according to the condition of the destination server in the data network.
